(19) United States
(12) Patent Application Publication
(10) Pub. No.: US 2007/0121961 A1
(43) Pub. Date: May 31, 2007

(54) POP noise processing circuit structure applying to panel display apparatus

(76) Inventor: Chih-Wei Tsai, Taoyuan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/488,759

(22) Filed: Jul. 19, 2006

(30) Foreign Application Priority Data
Jul. 22, 2005 (TW) 94124850

(51) Int. Cl. H04B 15/00

(52) U.S. Cl. 381/94.5; 381/94.1

(57) ABSTRACT

This invention discloses a POP noise processing circuit structure applying to an output apparatus. Therein, the output apparatus is a panel display apparatus. The POP noise processing circuit structure comprises at least one first processing unit, a second processing unit, an operational amplifier processing unit, and an audio POP noise processing unit. The first processing unit provides an audio signal to the operational amplifier processing unit, and the second processing unit provides a system signal to the audio POP noise processing unit that provides a mute signal to the operational amplifier processing unit. When the output apparatus is in a shutdown mode or a mute mode, the audio signal includes a high voltage pulse, and utilizes the circuit characteristic of the audio POP noise processing unit to eliminate the POP noise caused from the high voltage pulse.

### FIELD OF THE INVENTION

The present invention relates to a POP noise processing circuit structure of an output apparatus, and in particularly, to a POP noise process circuit structure comprising a POP noise process unit in order to remove the POP noise produced from the ON-OFF mode or mute mode of the POP noise processing circuit structure.

### BACKGROUND OF THE INVENTION

The liquid crystal display (LCD) flat panel display is an interesting product of the optoelectronic industry. The products related to LCD display are popular and widespread in our daily life. The LCD applications will be introduced in the near future as the coming of digital information era and familiarization of human with digital display apparatus. LCD TVs have the advantages of big size, flat panel, less occupancy, low radiation and high resolution for being the most suitable display apparatus in digital homes. However, there exists a problem of low quality of audio performance in LCD display apparatus. This problem is further described as followings.

In FIG. 1, it is a block diagram of an output apparatus in the prior art. The output apparatus 10 can be a flat panel display apparatus or an LCD TV. The output apparatus 10 comprises at least one first processing unit (First PU) 11, one second processing unit (Second PU), one operational amplifier processing unit (OP PU) 13 and one speaker 14 wherein the first processing unit 11 provides an audio signal into the operational amplifier processing unit 13 and the audio signal is further amplified by the operational amplifier processing unit 13; the second processing unit 12 provides a mute sound signal into the operational amplifier processing unit 13; and the operational amplifier processing unit 13 transmits processed audio signal into the speaker 14. Moreover, the first processing unit 11 can be an audio signal processing unit, and the second processing unit 12 can be a microcontroller or a video processing unit.

In FIG. 2, it is an application diagram of an output apparatus in the prior art. The output apparatus 10 can be a flat panel display apparatus or an LCD TV. FIG. 2 further illustrates the audio signal 111 including one high voltage pulse 19. Referring to the output apparatus 10 in FIG. 2, while the first processing unit 11 and second processing unit 12 are in a mute mode or shutdown mode, there is a POP noise from the speaker 14 at the time the switch 18 is in the shutdown (OFF). The transmission speed of mute signal 121 of the second processing unit 12 to the operational amplifier processing unit 13 is slower than that of the audio signal 111 of the first processing unit 11 and causes a high voltage pulse 19 of audio signal 111 directly amplified by the operational amplifier processing unit 13 in the mute mode or at the time the system is shutdown. Thus, an undesirable audio signal 131 is received and outputted by the speaker 14 deteriorating the audio quality.

People can only respond to the audio signal whose frequency is from 20 Hz to 20K Hz. Neither audio signal with pulse period less than 50 ms, nor audio signal with frequency larger than 20K Hz can be heard by the ears of human. If the high voltage pulse 19, created as the first processing unit 11 in FIG. 2 is in the mute mode or at the time of shutdown, has a frequency less than 20 Hz or larger than 20K Hz, the POP noise can be ignored by the ears of human. Limited by the properties of the first processing unit 11 in the prior art, the high voltage pulse 19, created as the first processing unit 11 is in the mute mode or at the time of shutdown, is transmitted into the operational amplifier processing unit 13 and amplified as a POP noise sound within the frequency range noticeable to the ears of human.

It is an object of the present invention to provide a POP noise processing circuit structure for eliminating the POP noise of the output apparatus and having improved qualities.

### SUMMARY OF THE INVENTION

The present invention provides a POP noise processing circuit structure for an output apparatus which can be a flat panel display apparatus or an LCD TV. The POP noise processing circuit structure can solve the problem of POP noise. The POP noise is an audio signal, amplified by the speaker, comprising a high voltage pulse produced by the output apparatus while the output apparatus is in the mute mode or at the time of turning off. Before the operational amplifier processing unit receives a mute signal, the high voltage pulse from the first processing unit is accepted by the operational amplifier processing unit and amplified by the speaker and causes POP noise sounds.

Therefore, the present invention provides a POP noise processing circuit structure not only comprising a first processing unit, a second processing unit, an operational amplifier processing unit and a speaker, but also a POP noise process unit coupling and between the second processing unit and the operational amplifier processing unit.

The features of the POP noise process unit can make the operational amplifier processing unit to receive the mute signal at the time earlier than that of outputting of the audio signal from the first processing unit. Thus, after receiving the mute signal at first, the undesirable audio signal from the first processing unit will be ignored by the operational amplifier processing unit. By this way, the POP noise sounds can be ignored.

For that reason, the POP noise process unit of the present invention manipulates the original mute signal received from the output apparatus and sends the manipulated mute signal to the operational amplifier processing unit at the time earlier than that of the arrival of the POP noise signal from the first processing unit. The operational amplifier processing unit processes the coming signals and enters the mute mode without the POP noise sounds created by the speaker in the mute mode or at the time of shutdown.

The features and advantages of the present invention are further disclosed and illustrated with the detail descriptions of preferred embodiments and accompanying drawings.

### BRIEF DESCRIPTION OF THE DRAWINGS

FIG. 1 is a block diagram of an output apparatus in the prior art;

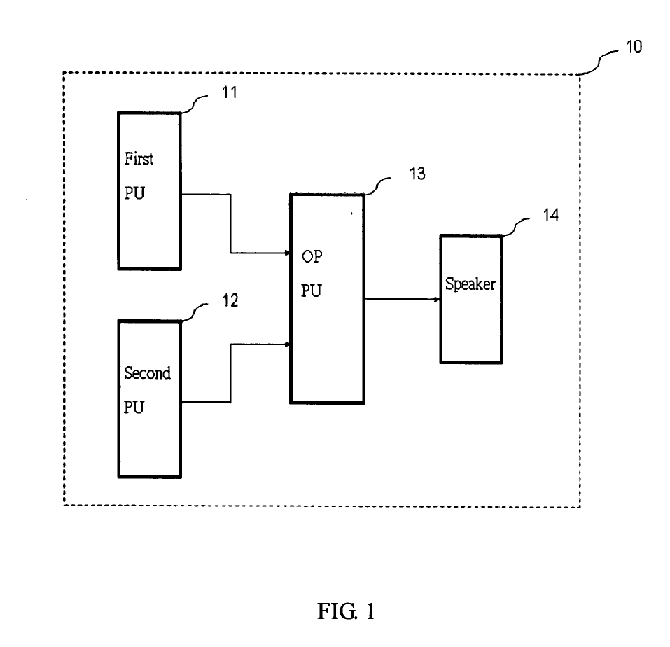

FIG. 2 is an application diagram of an output apparatus in the prior art;

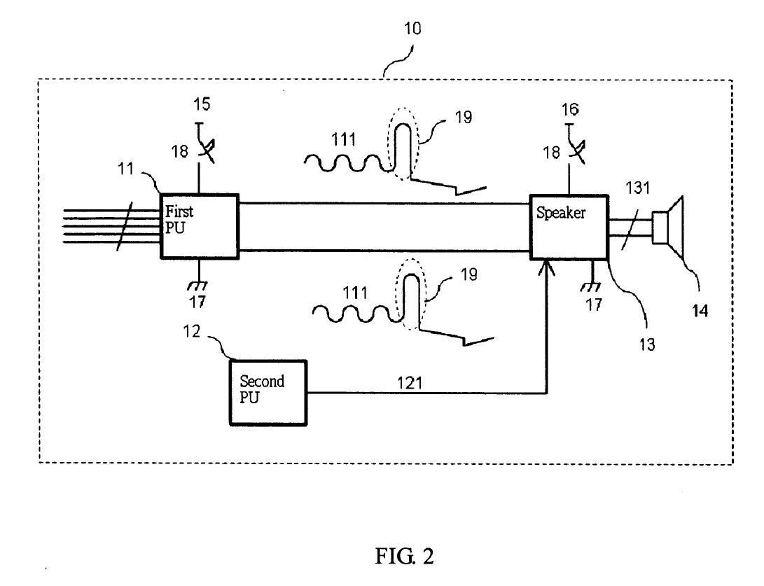

FIG. 3 is a block diagram of an output apparatus according to the present invention;

FIG. 4 is an application diagram of an output apparatus according to the present invention; and

FIG. 5 is a block diagram of a POP processing unit (POP PU) of the present invention.

### DETAILED DESCRIPTION OF THE PREFERRED EMBODIMENTS

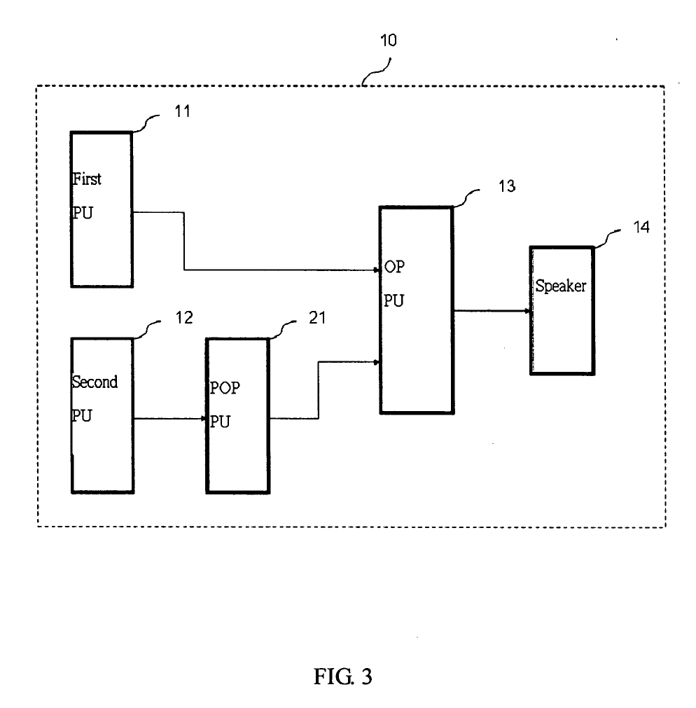

In FIG. 3, it is a block diagram of an output apparatus according to the present invention. The output apparatus 10 can be a flat panel display apparatus or an LCD TV. Referring to FIG. 3, the output apparatus 10 comprises a first processing unit 11, a second processing unit 12, an operational amplifier processing unit 13, a speaker 14 and a POP noise process unit (POP PU) 21 coupling and between the second processing unit 12 and the operational amplifier processing unit 13. The POP noise process unit 21 not only integrates the signals transmitted from the second processing unit 12, but also outputs a mute signal manipulated by the POP noise process unit 21 into the operational amplifier processing unit 13. The first processing unit 11 transmits a signal into the operational amplifier processing unit 13 which amplifies signals received. Moreover, the first processing unit 11 can be an audio processing unit and the second processing unit 12 can be a microcontroller or a video processing unit.

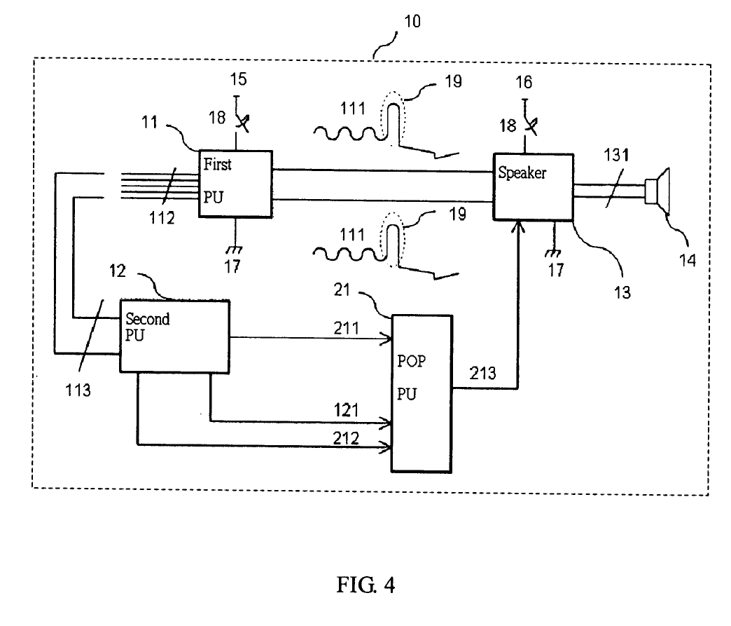

FIG. 4 is an application diagram of an output apparatus according to the present invention. The output apparatus 10 can be a flat panel display apparatus or an LCD TV. FIG. 4 illustrates more signals in the system described in FIG. 3 wherein the signals comprises a system mute signal 121, an audio testing signal 211 and a video mute control signal 212. The first processing unit 11 can be an audio processing unit providing decode functions for external audio signals 112. The second processing unit 12 can be a video processing unit or a microcontroller providing decode functions for external video signals 113, too. While the first processing unit 11 and the second processing unit 12 are in the mute mode or at the time of shutdown, an audio signal 111 including a high voltage pulse 19 is produced by the first processing unit 11. Meanwhile, the POP noise process unit 21 manipulates the system mute signal 121 from the second processing unit 12, audio testing signal 211 and mute control signal 212 of video system, and then sends a manipulated mute signal 213 into the operational amplifier processing unit 13. With circuit designs of the POP noise process unit 21 according to the present invention, the manipulated mute signal 213 arrives at the operational amplifier processing unit 13 earlier than the audio signal 111 from the first processing unit 11 does. Thus, the audio signal 111 from the first processing unit 11 will not be amplified by the operational amplifier processing unit 13 and not be transmitted into the speaker 14 in the form of an amplified audio signal 131. The POP noise signal is blocked according to the present invention.

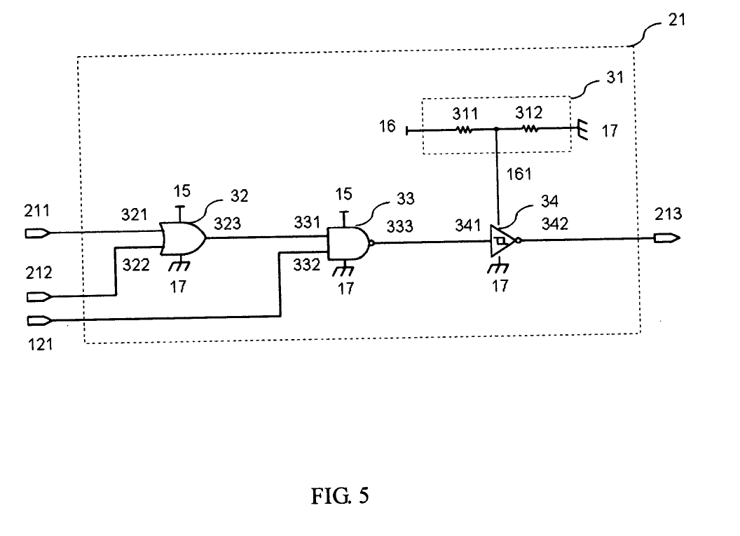

More detailed descriptions about the POP processing unit in FIG. 4 of the present invention are illustrated in FIG. 5. A POP noise process unit 21 in the embodiment of FIG. 5 comprises a pair of carbon film fixed resistors 311, 312 forming a voltage divider circuit 31; an OR logic gate circuit 32; a NAND logic gate circuit 33; an inverter logic gate circuit 34; a first supply voltage 15; a second supply voltage 16; and a common ground 17. The voltage divider circuit 31 comprising a carbon film fixed resistor 311 and a carbon film fixed resistor 312 wherein the carbon film fixed resistor 311 connects the carbon film fixed resistor 312 with a metal material of good conductivity and the voltage divider circuit 31 is supplied with the second supply voltage 16 and grounded with the common ground 17. A divided voltage point 161 is obtained from the voltage divider circuit 31 and then used as the supply voltage of the inverter logic gate circuit 34.

In FIG. 5, the input terminals 321, 322 of the OR logic gate circuit 32 couple with the audio testing signal 211 and the mute control signal 212 of video system from the second processing unit 12. Moreover, the output terminal 323 of the OR logic gate circuit 32 connects to the input terminal 331 of the NAND logic gate circuit 33. The input terminal 332 of the NAND logic gate circuit 33 connects to the system mute signal 121 outputted from the second processing unit 12. Moreover, the output terminal 333 of the NAND logic gate circuit 33 connects to the input terminal 341 of the inverter logic gate circuit 34. Furthermore, the output terminal 342 of the inverter logic circuit 34 connects to the mute signal 213 of the operational amplifier processing unit 13.

In addition, FIG. 5 also illustrates the arrival time to the operational amplifier processing unit 13 of the mute signal 213 is earlier than that of the audio signal 19 while the output apparatus 10 is in the mute mode or at the time of shutdown. The POP noise process unit 21 utilizes that the turning off time of the second supply voltage 16 is earlier than that of the first supply voltage 15, and the voltage divider circuit 31 of the POP noise process unit 21 couples with the second supply voltage 16 to send the mute signal at the time before the audio signal arrives the operational amplifier processing unit 13.

Although the features and advantages of the embodiments according to the preferred invention are disclosed, it is not limited to the embodiments described above, but encompasses any and all modifications and changes within the spirit and scope of the following claims.

What is claimed is:

1. A POP noise processing circuit structure for an output apparatus, comprising:
a first processing unit for providing at least one audio signal;
a second processing unit for providing at least one system signal;
an operational amplifier processing unit for receiving said audio signal; and
a POP process unit for receiving said system signal and for providing a mute signal coupling with said operational amplifier processing unit.

2. The POP noise processing circuit structure according to claim 1, wherein the POP noise process unit comprises:
an OR logic gate circuit;
a NAND logic gate circuit coupling with said OR logic gate circuit;
an inverter logic gate circuit coupling with said NAND logic gate circuit; and
a voltage divider circuit for providing a supply voltage to said inverter logic gate circuit.

3. The POP noise processing circuit structure according to claim 1, wherein the output apparatus is a flat panel display apparatus.

4. The POP noise processing circuit structure according to claim 1, wherein the output apparatus is an LCD TV.

5. The POP noise processing circuit structure according to claim 1, wherein the first processing unit is an audio processing unit.

6. The POP noise processing circuit structure according to claim 5, wherein the audio processing unit provides a decode function for external audio signals.

7. The POP noise processing circuit structure according to claim 6, wherein the audio processing unit couples with a first supply voltage.

8. The POP noise processing circuit structure according to claim 1, wherein the second processing unit is a microcontroller.

9. The POP noise processing circuit structure according to claim 8, wherein the microcontroller is a video processing unit.

10. The POP noise processing circuit structure according to claim 9, wherein the video processing unit provides a decode function for external video signals.

11. The POP noise processing circuit structure according to claim 10, wherein the video processing unit couples with a first supply voltage.

12. The POP noise processing circuit structure according to claim 1, wherein the operational amplifier processing unit is an audio operational amplifier processing unit.

13. The POP noise processing circuit structure according to claim 12, wherein the audio operational amplifier processing unit couples with a speaker.

14. The POP noise processing circuit structure according to claim 13, wherein the audio operational amplifier processing unit couples with a second supply voltage.

15. The POP noise processing circuit structure according to claim 1, wherein the mute signal is a system mute signal of the output apparatus.

16. The POP noise processing circuit structure according to claim 2, wherein the voltage divider circuit couples with a second supply voltage.
